(19) United States
(12) Patent Application Publication
(10) Pub. No.: US 2004/0049404 A1
(43) Pub. Date: Mar. 11, 2004

(54) System for delivering goods

(76) Inventor: Roger Murphy, Tanworth-in-Arden (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/610,468

(22) Filed: Jun. 30, 2003

Related U.S. Application Data
(63) Continuation of application No. PCT/GB02/00001, filed on Jan. 3, 2002.

(30) Foreign Application Priority Data
Jan. 4, 2001 (GB) 0100147.8
Mar. 2, 2001 (GB) 0105201.8

(51) Int. Cl. G06F 17/60

(52) U.S. Cl. 705/1

(57) ABSTRACT

A system for delivering goods from a vendor to an intended recipient including a goods carrier to carry the goods from the vendor to the intended recipient, a call center, and a telecommunications system. The call center is adapted automatically to send a request signal to the intended recipient via the telecommunications system when an order for the goods is received by the vendor, and to receive a return signal via the telecommunications system from the intended recipient. The return signal indicates the intended recipient's availability for delivery of the goods. On receipt of the return signal from the intended recipient, the call center sends an advice signal to the vendor and/or the carrier, whereby the carrier is instructed to deliver the goods to the intended recipient at a time and place determined from the return signal.

### CROSS-REFERENCE TO RELATED APPLICATIONS

Not Applicable. This is a continuation of PCT patent application No. PCT/GB02/00001 filed Jan. 3, 2002. Priority is claimed to United Kingdom patent application Serial No. 0100147.8 filed Jan. 4, 2001, and to United Kingdom patent application Serial No. 0105201.8 filed Mar. 2, 2001.

### STATEMENT REGARDING FEDERALLY SPONSORED RESEARCH OR DEVELOPMENT

Not Applicable.

### TECHNICAL FIELD

This invention relates to a system for the delivery of goods, particularly where it is desirable that the intended recipient be present to receive the goods.

### BACKGROUND OF THE INVENTION

Where goods are to be delivered to a private address of an intended recipient, for example using a courier service, the goods are typically delivered from the vendor to the intended recipient by a goods carrier which transports the goods to the appropriate address. Often the goods are too bulky to be posted through a mail box. Commonly the intended recipient is not present at the address at the time when the goods are delivered, in which case, the goods either have to be returned to a depot for delivery another time which is costly for the delivery company, or left somewhere convenient outside the premises, where they may be vulnerable to theft and/or the weather.

While it would be possible to determine a suitable delivery time by either the vendor or the delivery company employing staff to telephone the intended recipient, this process would be time consuming, and hence expensive. Also, where all occupants at a private address work, or otherwise are absent, the use of a telephone to establish a suitable delivery time, can be problematic.

It is known to provide a safe accessible from the exterior of the premises, and in which the goods may be deposited. An access code for which is communicated to the delivery company. However, to provide such a safe is expensive, and communication of the access code to the person delivering the goods gives rise to an extra administrative step in the delivery process and can be unreliable. Furthermore, if perishable goods, such as frozen food, are left outside the premises or in a safe until the intended recipient returns, the quality of the goods may deteriorate while outside or in the safe. For example, frozen food may defrost or goods may e damaged by rain.

### BRIEF SUMMARY OF THE INVENTION

According to a first aspect of the invention, a system is provided for delivering goods from a vendor to an intended recipient. The system includes a goods carrier to carry the goods from the vendor to the intended recipient, a call center, and telecommunications means. The call center may automatically send a request signal to the intended recipient via the telecommunications means when an order for the goods is received by the vendor, and receives a return signal via the telecommunications means from the intended recipient which indicates the intended recipient's availability for delivery of the goods. The call center is adapted to send an advice signal to the vendor and/or the carrier on receipt of the return signal from the intended recipient, whereby the carrier is instructed to deliver the goods at a time and place determined from the return signal.

Thus, the goods may be delivered reliably by the carrier to the intended recipient when the intended recipient is available to receive them. The need for the carrier to return with the goods to a depot and to attempt to deliver them at an alternative time, is avoided, resulting in a more reliable and efficient delivery of the goods.

In one system the call center is adapted on receipt of the return signal from the intended recipient, to send an advice signal to the vendor. The vendor has means to identify the goods to be delivered to the intended recipient and to indicate the intended recipient's availability for delivery of the goods. An identifying means is attached to the goods to be delivered. Thus when the carrier collects the goods from the vendor for delivery to the intended recipient, the carrier may have means to read the identifying means, electronically, or manually, or automatically optically, or by any other means, to determine an appropriate time and/or day for delivery of the goods to the intended recipient.

If necessary the goods may be held at a depot until a time close to the appropriate time and/or day for delivery, or the goods may be delivered straight away. The return signal from the intended recipient may indicate a particular day and/or time interval during the day when the goods may be delivered, and thus the possibility of the intended recipient being unavailable and/or absent when the goods are delivered may be avoided.

If desired, the call center may be adapted on receipt of the return signal from the intended recipient, to send an advice signal to the carrier. From the advice signal, the carrier determines the intended recipient's availability for delivery of the goods. Thus the carrier may use this information to determine when the goods may be collected most conveniently from the vendor, for example, when the carrier has a vehicle in the vicinity of the vendor.

The vendor may send an initiating signal to the call center in response to an order for goods being received, whereby the call center automatically generates the advice signal to the intended recipient. The initiating signal may be sent when the vendor has the goods ready for delivery, or when the vendor can predict that the goods will be ready for the carrier to collect. Where, for example, the vendor is a distributor, the initiating signal may be sent to the call center as soon as the vendor has possession of the goods as soon as an order is received, or when the goods are delivered to the vendor. Where the vendor is a manufacturer, the initiating signal may be sent to the call center when the goods have been manufactured or while the goods are still being manufactured. In each case the initiating signal may indicate when the goods are to be ready to be delivered to the intended recipient so that the call center does not send the advice signal to the intended recipient or accept instructions via the return signal which could lead to the intended recipient indicating that he is available to receive the goods before the vendor has the goods ready or the carrier can deliver the goods.

Preferably, the advice signal is a simple signal which indicates that a return signal via the telecommunications means from the intended recipient is required to indicate the intended recipient's availability for delivery of the goods. Most simply, the system includes an advice signal receiving means located at the intended recipient's address. The advice signal receiving means receives the advice signal and generates an audible and/or visual signal to indicate that a return signal is required.

The signal receiving means may be of the kind which automatically identifies when a telecommunications advice signal is sent to the intended recipient's address, for example, by identifying the calling telephone number of the call center. The signal receiving means may operate independently of a telephone at the intended recipient's address. Preferably, the telecommunication means includes telephone apparatus, and the return signal which indicates the intended recipient's availability for delivery of the goods is generated by the intended recipient using the telephone apparatus. A conventional touch tone telephone, for example, may generate tones to indicate to the call center the intended recipient's availability for delivery of the goods, and/or other information.

The call center may automatically respond to a return signal to automatically determine the intended recipient's identity and to correlate the intended recipient with the goods. However, where the call center is unable to determine the intended recipient's identity from the return signal, for example because the return signal is generated on a different telephone connection to that along which the advice signal was sent, the call center may be adapted to seek this information from the caller sending the return signal.

In addition to indicating availability for receiving the goods, the caller generating the return signal may give an indication of a delivery address for the goods alternate to the intended recipient's own address. The call center may be adapted to discern from the return signal the alternate delivery address and to advise the vendor and/or carrier of the alternate address to which the goods are to be delivered. This may be achieved by generating appropriate tones where the system includes a touch tone telephone.

It will be appreciated that the advice and/or return signal may be a text signal sent via a mobile telecommunications network to a mobile telephone, or other short messaging system device. The advice and/or return signal may be received/generated via a computer or the like as desired. Preferably, the initiating signal from the vendor to the call center is a data signal, for example sent as a data packet via the telecommunication means from the vendor to the carrier.

A second aspect of the invention involves a method of delivering goods from a vendor to an intended recipient using a system including a goods carrier to carry the goods from the vendor to the intended recipient, a call center, and telecommunications means. The method including automatically sending a request signal from the call center to the intended recipient via the telecommunications means when an order for the goods is received by the vendor, receiving at the call center a return signal via the telecommunications means from the intended recipient, which return signal indicates the intended recipient's availability for delivery of the goods, and on receipt of the return signal from the intended recipient, sending an advice signal from the call center to the vendor and/or the carrier, whereby the carrier is instructed to deliver the goods at a time and place determined from the return signal.

According to a third aspect of the invention a call center is provided for use in the system of the first aspect of the invention or the method of the second aspect of the invention. The call center is adapted to automatically send a request signal to an intended recipient via a telecommunications means in response to an order for goods received by a vendor, and to receive a return signal via the telecommunications means from the intended recipient which indicates the intended recipient's availability for delivery of the goods. On receipt of the return signal from the intended recipient, the call center sends an advice signal to the vendor and/or the carrier, whereby the carrier is instructed to deliver the goods at a time and place determined from the return signal.

According to a fourth aspect of the invention, a request signal receiving means is provided for use in the system of the first aspect of the invention or the method of the second aspect of the invention. The request signal receiving means is located at the address of the intended recipient of the goods to be delivered. The receiving means includes a caller identification means which is responsive to an advice signal from the call center to generate an audible and/or visual signal to indicate receipt of the advice signal.

Various objects and advantages of the invention will become apparent from the following detailed description of the invention and the accompanying drawings.

### BRIEF DESCRIPTION OF THE DRAWINGS

FIG. 1 is an diagrammatic view of a system for delivering goods, in accordance with the invention.

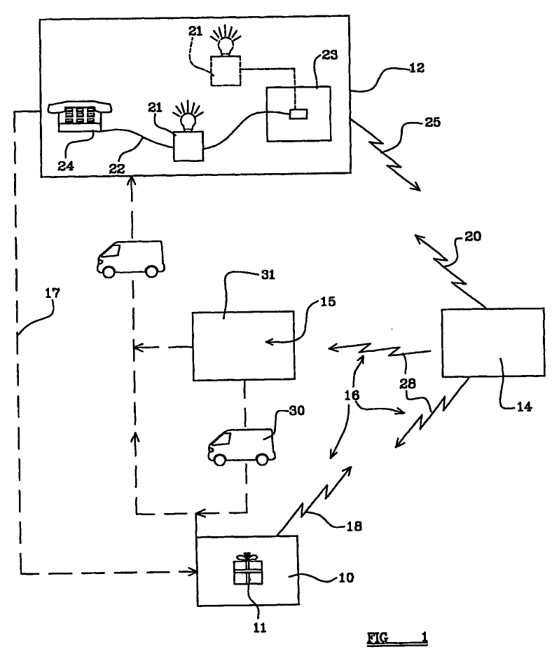

### DETAILED DESCRIPTION OF THE INVENTION

Referring to the drawing, a system for delivering goods 11 from a vendor 10 to an intended recipient's address 12 includes a call center 14, a goods carrier 15, and a telecommunications means 16. When the vendor 10 receives an order for goods 11, for example, by telephone communication indicated at 17 in the drawing, or by fax, e-mail or mail, the vendor 10 processes the order.

Either when the goods 11 are made (where the vendor is a manufacturer) or received or otherwise available, or prior to them being available but when their availability can be predicted, the vendor 10 sends an initiating signal 18 to the call center 14 via the telecommunications means 16. Preferably the initiating signal 18 is generated automatically by the vendor 10, and is a data signal sent as a packet of data, for example with a regular transfer of data, daily, hourly or otherwise. The initiating signal 18 includes information concerning the goods 11 order, and may for example contain information as to when the goods 11 will be available for collection from the vendor 10 for delivery to the intended recipient, as well as details of the intended recipient.

The call center 14 is fully automated and in response to receiving the initiating signal 18, either immediately or at a time appropriate to the availability of the goods 11 at the vendor 10, the call center 14 generates a request signal 20 which is communicated to the intended recipient's address 12 via the telecommunication means 16. The request signal 20 may be a telephonic signal as hereinafter described with reference to the drawing, but may be a text signal sent to a mobile telephone network, or a data signal sent to a computer at the recipient's address 12, or to an intended recipient via the Internet.

Most simply, where the request signal 20 is a telephonic signal, the request signal 20 is recognized by a request signal receiving means 21 which in response may generate an audible and/or visual signal. In the example shown in the drawing, the request signal receiving means 21 is of the kind which is either in series with the telephone 24 between the telephone 24 and a telephone socket 23 as shown in full lines in the figure, as of the kind which is in parallel with the telephone 24 as indicated in dashed lines in the figure. Further alternatively the request signal receiving means 21 may be of the kind which simply clips into the telephone wire at the socket 23. When a request signal is sent from the call center 14 to the telephone number at the recipient's address 12, the receiving means 21 identifies the source of the call as being the call center 14, preferably by means of a Caller ID signal, and the warning signal is activated.

Preferably the request signal receiving means 21 and the request signal are such that transmission of a request signal over the telecommunication means does not cause the telephone 24 to ring or any answer machine which may then be connected to the socket 23 to be activated. The request signal receiving means 21 may be of an alternative kind, and may even be built into the telephone 24 itself. In another example, the request signal receiving means 21 may include a keypad whereby information may be conveyed back to the call center 14 via the telecommunication means 16, using the keypad, in a return signal to indicate the intended recipient's availability to receive the goods 11. Also, the request signal receiving means 21 may alternatively be connected to the telephone socket 23 in parallel with the telephone 24.

Telecommunication devices which are responsive to certain selected calls are known and so further detailed description is not considered necessary. It is not necessary for a telephone 24 to ring, for the advice signal to be identified. Where the request signal is a telephone call, if a call to the telephone 24 does not originate from the call center 14, the request signal identifying means 21 will not recognize the source of the call and the call will pass to the telephone 24, or an answer phone, if provided, in the usual way.

Because of the operating cost savings which can be made utilizing the present invention, in that the number of fruitless attempts at delivering the goods 11 to addresses where there is no one to receive them, can be reduced or even eliminated, it is envisaged that a request signal receiving means 21 may be provided free of charge to a householder, to encourage the use of the system with the result that even greater cost savings can be made.

The warning signal remains activated until the intended recipient for the goods 11 cancels the warning. Thus the request signal 20 may be received while the intended recipient is out, and acted upon once the intended recipient returns to the address 12.

The intended recipient or his nominee may then make a conventional return telephone call to the call center 14, or may use a mobile phone short messaging service to send a text message to the call center 14. Preferably the call center 14 is adapted automatically to identify the caller by identifying the telephone number from which the intended recipient makes the return call. However, if the intended recipient makes a call to the call center 14 from another telephone line, for example, from a mobile telephone, the call center 14 may not be able to identify the caller. In that circumstance, the call center 14 may be adapted to make an enquiry of the caller, for example using pre-recorded or digitally created messages, in order to determine the caller's identity. The caller may have a code which is keyed into the telephone for identification purposes.

Information concerning the caller's identity when required by the call center 14, and information concerning the availability of the intended recipient to accept delivery of the goods 11 he has ordered, may be communicated to the call center 14 using the telephone 24, e.g. using touch tone buttons of the telephone 24, in response to pre-recorded, or digitally created messages from the call center 14. The system may be set up to enable an intended recipient to indicate a day, and/or part of a day, e.g. “between 12 and 1 pm” in which the intended recipient of the goods 11 will be available at the address 12 to take delivery of the goods 11.

The system may additionally be set up to enable the intended recipient to advise the call center 14 of an alternative address to which the goods 11 may be delivered, so, for example, the intended recipient may arrange delivery to a next door neighbor, or a work address. All this information is returned to the call center 14 in a return signal 25 which is communicated to the call center 14 via the telecommunications means 16.

Where the request signal 20 is sent by text messaging or data to a computer, the return signal 25 may similarly be a text message or data signal sent to the call center 14 via the telecommunications means 16. Upon receipt of the return signal 25, the call center 14 may automatically send an advice signal 28 to one or both of the vendor 10 and/or the carrier 15. The vendor 10 may thus attach to the goods 11 an identifying means such as a label or tag, in addition to an address label for example, the identifying means indicating when the goods 11 may be delivered to the intended recipient 12, or his nominee. For example the identifying means may include a bar code, a machine readable magnetic strip or chip or the like.

The carrier 15 may collect the goods 11 and read the identifying means electronically, and/or optically (manually or automatically) and/or visually, and thus be made aware of when the goods 11 may reliably be delivered with someone present at the intended recipient's address 12, or an alternative address, to receive the goods 11. A driver of the carrier's vehicle 30 may also be provided with a check list or delivery schedule, where for example the driver has several consignments of goods 11 to deliver to different addresses at specified times.

The carrier 15 may collect the goods 11 in a vehicle 30, e.g. dispatched from a depot 31, and the goods 11 may be delivered directly to the intended recipient or stored at the or another depot 31 until due for delivery. Preferably, however, the vendor 10 does not dispatch the goods 11 until the intended recipient is ready to receive the goods 11 thus avoiding the need to store the goods 11 at the or other depot 31, at least for any significant length of time.

The goods 11 may be transported by the carrier 15 from the vendor 10 to a regional hub, from where they may be transported to a local depot and then on to the intended recipient. Thus, a different delivery vehicle 30 may be used for each leg of the journey, and the logistics of delivering a large number of goods to various locations throughout the country may be simplified.

The carrier 15 may dispatch the vehicle 30 to the vendor 10 on a regular basis e.g. daily or weekly, or when instructed to do so by the vendor 10, or, preferably, in response to receiving the advice signal 28. In each case the carrier 15 may be made aware of when the goods 11 may be delivered to the intended recipient, and thus collection of the goods 11 from the vendor 10 may be prearranged so as most efficiently to use the resources of the carrier 15. If desired, the advice signal 28, or a signal from the depot 31 may be communicated to a collection/delivery vehicle 30 of the carrier 15 using a mobile telephone, or radio link as desired, and/or to a depot. The vehicle 30 may communicate its position to the depot 31 having determined its position via the Global Positioning Network so that the carrier vehicle's collection/delivery route can be optimized.

Where the initiating signal 18 from the vendor 10 to the call center 14 indicates that the goods 11 will not be ready for collection until a future date, this information may too be communicated to the carrier 15 from the call center 14, or from the vendor 10 if desired, to ensure that the carrier 15 does not seek to collect goods 11 from the vendor 10 before the goods 11 are ready for collection.

The system described above may be used to enable a recipient of goods 11 to return the goods to the vendor 10, where for example the goods 111 are unsatisfactory, as follows. The recipient may initiate a call to the call center 14 to indicate that he has goods for collection, and the initiating call may indicate when the goods 11 can be collected, again using the touch tones of the telephone 24, or by text messaging/data transfer as desired. The call center 14 is preferably adapted automatically to process such a call and to send an appropriate advice signal to the carrier 15 to collect the goods 11 and to deliver them back to the vendor 10. The carrier 15 then knows when the recipient will be at the address 12, or at a nominated address, so that the goods 11 may be reliably collected for return.

It will be appreciated that the system of the invention may include a plurality of vendors 10, and the particular vendor 10 sending an initiating signal 18 to the call center 14 may be identified in the initiating signal 18. Thus a single call center 14 may be used to service a plurality of vendors 10 and a plurality of recipients for each vendor's goods 11.

If desired, the initiating signal 18 from the or any vendor 10, may include information concerning the identify of the vendor 10 and the nature of the goods 10, and this information may be communicated to the intended recipient, where the request signal receiving means 21 is sufficiently sophisticated, via the request signal 20, and/or by pre-recorded or digitally prepared message from the call center 14 when the intended recipient makes a return call 25 to the call center 14. The call center 14 and/or vendor 10 may also communicate information concerning the size and/or nature etc. of the goods 11 to be delivered, to the carrier 15, so that the carrier 15 can send an appropriate vehicle 30 and/or appropriate equipment to collect and deliver the goods 11, for example, where the goods 11 are large and/or bulky.

The call center 14 may be adapted to receive conventional voice return calls, for example in the event of a query or information being required which cannot readily be automatically communicated. Such voice calls may be made to an alternative telephone number of the call center 14, or the facility may be selected using touch tone buttons for example, on the telephone 24.

The features disclosed in the foregoing description, or the following claims, or the accompanying drawing, expressed in their specific forms or in terms of a means for performing the disclosed function, or a method or process for attaining the disclosed result, as appropriate, may, separately, or in any combination of such features, be utilized for realizing the invention in diverse forms thereof. It will be appreciated that various modifications and changes may be made to the above described preferred embodiment of a system for delivering goods without departing from the scope of the following claims.

1. A system for delivering goods from a vendor to an intended recipient, the system including a goods carrier to carry the goods from the vendor to the intended recipient, a call center, and telecommunications means, the call center being adapted automatically to send a request signal to the intended recipient via the telecommunications means when in response to an order for the goods is received by the vendor, and to receive a return signal via the telecommunications means from the intended recipient which indicates the intended recipient's availability for delivery of the goods, the call center being adapted on receipt of the return signal from the intended recipient, to send an advice signal to the vendor and/or the carrier, whereby the carrier is instructed to deliver the goods at a time and place determined from the return signal.

2. A system according to claim 1, and wherein the call center is adapted on receipt of the return signal from the intended recipient, to send an advice signal to the vendor, the vendor having means to generate an identifying means identifying the goods to be delivered to the intended recipient and indicating the intended recipient's availability for delivery of the goods, and to attach the identifying means to the goods to be delivered.

3. A system according to claim 1, and wherein the call center is adapted on receipt of the return signal from the intended recipient, to send an advice signal to the carrier, the carrier being adapted to determine from the advice signal the intended recipient's availability for delivery of the goods.

4. A system according to claim 2, and wherein the carrier has means to read the identifying means attached to the goods to be delivered.

5. A system according to claim 1, and wherein the vendor is adapted to send an initiating signal to the call center in response to an order for goods being received whereby the call center automatically generates the advice signal to the intended recipient.

6. A system according to claim 1, and wherein the advice signal is a simple signal which indicates that a return signal via the telecommunications means from the intended recipient is required to indicate the intended recipient's availability for delivery of the goods.

7. A system according to claim 1, and wherein the system includes an advice signal receiving means located at the intended recipient's address, which advice signal receiving means is adapted to receive the advice signal and generate an audible and/or visual signal to indicate that a return signal via the telecommunications means from the intended recipient which indicates the intended recipient's availability for delivery of the goods, is required.

8. A system according to claim 7, and wherein the telecommunication means includes a telephone apparatus, and the return signal which indicates the intended recipient's availability for delivery of the goods, is generated using the telephone apparatus.

9. A system according to claim 1, and wherein the return signal additionally contains an indication of an alternative delivery address for the goods to the intended recipient's own address, and the call center is adapted to discern from the return signal the alternative delivery address and to advise the vendor and/or carrier of the alternative address to which the goods are to be delivered.

10. A system according to claim 1, and wherein the call center is adapted automatically to discern from the return signal the identity of the intended recipient and to correlate this information with the goods to be delivered.

11. A system according to claim 10, and wherein when the call center is unable to determine from the return signal the identity of the intended recipient, the call center is adapted to seek this information from the caller sending the return signal.

12. A method of delivering goods from a vendor to an intended recipient, using a system including a goods carrier to carry the goods from the vendor to the intended recipient, a call center, and telecommunications means, the method including automatically sending a request signal from the call center to the intended recipient via the telecommunications means when an order for the goods is received by the vendor, receiving at the call center a return signal via the telecommunications means from the intended recipient, which return signal indicates the intended recipient's availability for delivery of the goods, and on receipt of the return signal from the intended recipient, sending an advice signal from the call center to the vendor and/or the carrier, whereby the carrier is instructed to deliver the goods at a time and place determined from the return signal.

13. The method of claim 12, and wherein the call center is adapted automatically to send a request signal to an intended recipient via a telecommunications means in response to an order for goods received by a vendor, and to receive a return signal via the telecommunications means from the intended recipient which indicates the intended recipient's availability for delivery of the goods, the call center being adapted on receipt of the return signal from the intended recipient, to send an advice signal to the vendor and/or the carrier, whereby the carrier is instructed to deliver the goods at a time and place determined from the return signal.

14. The method of claim 12, and wherein the request signal receiving means is located at the address of the intended recipient of the goods to be delivered, the receiving means including a caller identification means which is responsive to an advice signal from the call center to generate an audible an/or visual signal to indicate receipt of the advice signal.

15. A system according to claim 1, and wherein the call center is adapted automatically to send a request signal to an intended recipient via a telecommunications means in response to an order for goods received by a vendor, and to receive a return signal via the telecommunications means from the intended recipient which indicates the intended recipient's availability for delivery of the goods, the call center being adapted on receipt of the return signal from the intended recipient, to send an advice signal to the vendor and/or the carrier, whereby the carrier is instructed to deliver the goods at a time and place determined from the return signal.

16. A system according to claim 1, and wherein the request signal receiving means is located at the address of the intended recipient of the goods to be delivered, the receiving means including a caller identification means which is responsive to an advice signal from the call center to generate an audible an/or visual signal to indicate receipt of the advice signal.
